(19) United States
(12) Patent Application Publication
(10) Pub. No.: US 2004/0088556 A1
(43) Pub. Date: May 6, 2004

(54) Using digital watermarking for protection of digital data

(76) Inventor: Charles R. Weirauch, Loveland, CO (US)

Correspondence Address: HEWLETT-PACKARD COMPANY, Intellectual Property Administration, P. O. Box 272400, Fort Collins, CO, 80527-2400, US

(21) Appl. No.: 10/285,875

(22) Filed: Oct. 31, 2002

(51) Int. Cl. G06F 12/14

(52) U.S. Cl. 713/193

(57) ABSTRACT

A digital watermark in a data file is used to encode separate watermark data. The digital watermark data must remain intact, or decryption may be prevented, or unscrambling may be prevented, or transmission may be prevented.

### FIELD OF INVENTION

This invention relates generally to methods and apparatus for discouraging the unauthorized copying or use of digital data.

### BACKGROUND

Information is increasingly being distributed in digital form. For example, audio and video files are commonly distributed as digital data on optical disks (CD and DVD), and over the Internet. There is an ongoing need to be able to control authorized copying by purchasers (for example, limit copies to a single authorized copy), or to prevent unauthorized copying.

The personal computing and consumer electronics industries have proposed a framework for protection of entertainment content (audio and video) on media. First, content to be protected is encrypted. Second, decryption keys are to be distributed with the content to be protected. Third, “content management information” (CMI), for example, copy control information, is to be distributed with the content to be protected. Fourth, devices that can decrypt the content are required (by license and/or law) to comply with the content management information, and to encrypt any digital output.

There are also proposed specifications for protected digital communication of content within a system. For example, in a computer system, data may be digitally transmitted from a source device (for example, an optical disk drive) to a sink device (for example, a display system). In proposed specifications, the transmitted data is encrypted, and a decryption key is transmitted separately from the encrypted data. In addition, data is transmitted in packets, where packets include header data in addition to user content, and header data includes “copy control information” (CCI). In the proposed specifications, encryption for digital transmission of content from a recorded medium is independent of the encryption on the medium.

CMI for digital entertainment content on media may be embedded into the original entertainment data by using a digital watermark. A digital watermark is an identification or data embedded in digital data created by modifying the digital data. Since the original data is modified, digital watermarks are typically confined to human perceptible data such as audio, image, and video, and the data is typically modified in such a way that the digital watermark is “transparent” (not perceptible).

In general, both encryption and digital watermarks are vulnerable to attack. Encryption keys can be discovered. A digital watermark can be removed or destroyed. In proposed standards, a digital watermark serves as an indicator of copy control if present, but it is theoretically possible to remove a digital watermark from data that originally included a watermark, resulting in useable unprotected user data. Protection depends on a combination of laws, licensing, and making encryption and digital watermarking physically and computationally difficult to defeat. There is a need for devices and methods that comply with industry standards, but with even stronger protection.

### SUMMARY

A digital watermark in a data file is used to encode separate watermark data. In one alternative, at least part of a decryption key is contained in the separate watermark data. As an alternative, or in addition to decryption key data, the separate watermark data may be used for transmission control and scrambling control of transmitted data.

### BRIEF DESCRIPTION OF THE DRAWINGS

FIG. 1A is a block diagram of a system in which an example embodiment of the invention may be implemented.

FIG. 1B is a block diagram illustrating an example of information recorded on a digital medium illustrated in FIG. 1A.

FIG. 1C is a block diagram illustrating an alternative example of information recorded on a digital medium illustrated in FIG. 1A.

FIG. 2 is a block diagram illustrating an example of information transmitted between a source device and a sink device illustrated in FIG. 1A.

### DETAILED DESCRIPTION

In various examples of the invention, digital watermark data must remain intact, or decryption may be prevented, or unscrambling may be prevented, or transmission may be prevented. Removal of digital watermark data will likely make the user data unusable, or less enjoyable due to perceptible artifacts. Accordingly, digital watermark data cannot be removed to defeat copy control without negatively affecting the user data.

In a first example embodiment, at least part of a decryption key is contained in digital watermark data embedded in part of the user data, and the digital watermark data is encrypted along with the user data. There may be at least two parts to one decryption key, or there may be two separate decryption keys. Using a first key, or a first part of a key, the part of the user data containing part of a decryption key is decrypted to expose digital watermark data. Then, the decryption key that is partially contained in the digital watermark data is used to decrypt the remaining part of the user data.

The watermark data may also contain CMI data. If the CMI data is inconsistent with various requirements, a compliant drive may refuse to decrypt the rest of the user data. For example, the CMI data may indicate that the user data should not exist on the type of media being read. If the watermark data is destroyed to destroy the CMI data, then the part of a decryption key contained in the watermark data will also be destroyed, and a drive will be unable to read the remaining part of the user data. As a result, the watermark data, and the associated CMI information, must remain intact.

The watermark data may also include transmission control instructions. When an encrypted file is transmitted from a source device to a sink device, the watermark data in the unencrypted data within the sink device may indicate whether more data should be requested from the source device. If the watermark data is destroyed, then a compliant sink device will not request additional user data from a source device.

The watermark data may also include unscrambling instructions. When an encrypted file is transmitted from a source device to a sink device, the unencrypted user data within the sink device may be scrambled, and the watermark data in the unencrypted user data may provide unscrambling instructions for the sink device. If the watermark data is destroyed, then a sink device cannot read the data in a useable form.

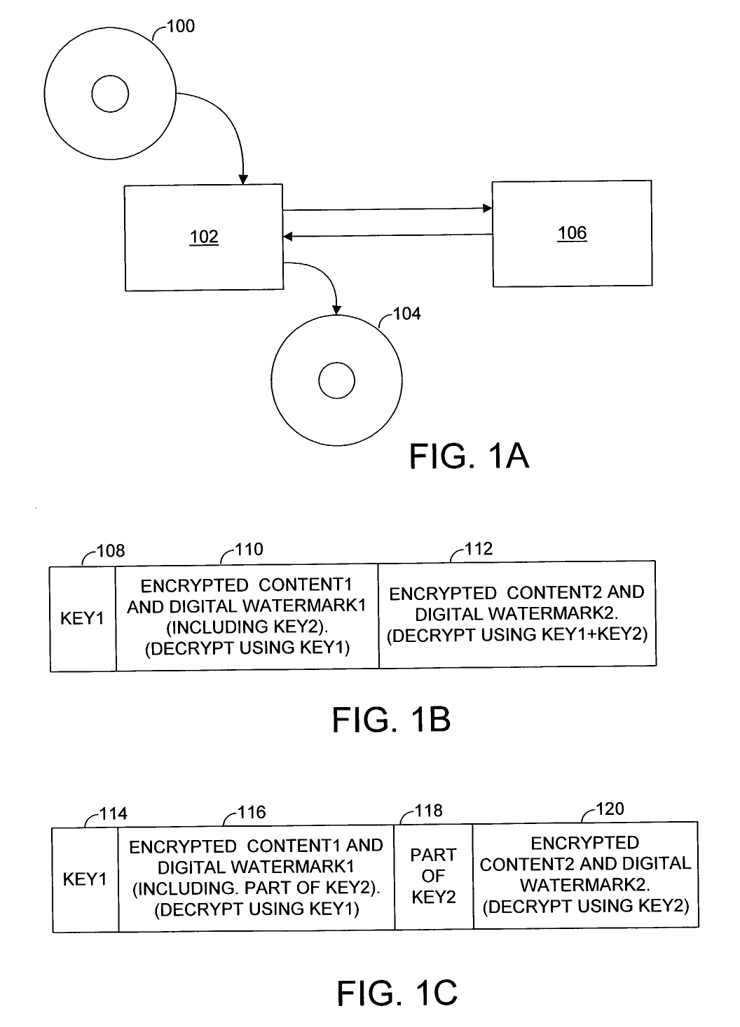

FIG. 1A illustrates an example system for reading, copying, and displaying user data. An optical disk 100 may be read in a compatible drive 102. The drive 102 may make a copy of the user data on optical disk 100 onto optical disk 104. The drive 102 may also act as a source device for the user data on optical disk 100, and drive 102 may transmit the user data from optical disk 100 to a sink device 106. Sink device 106 may transmit various commands and control data back to the source device 102.

FIG. 1B illustrates a first example embodiment of data recorded on optical disk 100. The data includes a first decryption key 108, first user content data 110, and second user content data 112. The first decryption key 108 is used by drive 102 to decrypt the first user content 110. The first decryption key 108 is part of a longer decryption key. The first user content includes a first digital watermark, and the first digital watermark includes a second part (KEY2) of the longer decryption key. For example, KEY1 may be a 64-bit decryption key, and KEY1+KEY2 may form a 128-bit decryption key. Second user content (112), including second digital watermark data, is decrypted using KEY1+KEY2.

FIG. 1C illustrates an alternative example embodiment of data recorded on optical disk 100. The data includes a first decryption key (KEY1) 114, first user content data 116, a part of a second decryption key (KEY2) 118, and second user content 120. The first user content data 116 includes first watermark data, which in turn includes a part of the second decryption key (KEY2). The first decryption key 114 is used to decrypt the first user content data 116. The complete second encryption key (KEY2) is used to decrypt the second user content (120), which includes second digital watermark data. For example, KEY1 may be a first 128-bit decryption key. KEY2 may be a second 128-bit decryption key, with 64 bits included in the first watermark data (116), and 64 bits stored separately (118).

In FIGS. 1B and 1C, KEY1 (FIG. 1A, 108; FIG. 1C, 114) may be recorded in a reserved area of the disk 100. Alternatively, KEY1 may be distributed throughout the bits recorded on disk 100. For example, U.S. Pat. No. 5,699,434 (Hogan), and divisions of that patent (U.S. Pat. No. 5,828,754, U.S. Pat. No. 6,278,386, and U.S. patent application Ser. No. 09/855,889) disclose multiple ways of embedding data within overhead bits. For example, in various embodiments of Hogan, data is embedded in the choice of encoding patterns, or within error correction areas, or within bits used to merge encoding patterns, all without altering the user data and without affecting the storage capacity for user data. Dispersing decryption key data throughout all the bits on a medium, as disclosed by Hogan, provides additional protection by making it difficult to determine which bits of information correspond to decryption key data.

Even if a file is decrypted, the presence of watermark data within the user data will prevent compliant drives from making an unauthorized copy. For example, compliant drives may not make a copy of digitally watermarked user data unless the data is on a medium that permits copying. Alternatively, a compliant drive may detect a digital watermark that indicates that one copy is permitted, and the drive may then make one copy, and the drive will include a digital watermark in the copy that indicates that no further copying is permitted. Accordingly, another level of protection depends on making it difficult to remove a digital watermark without also destroying the user data. There are robust methods of digital watermarking that can survive common data manipulations, and in which it is hard to remove or destroy the digital watermark without also destroying the data. For example, in U.S. Pat. No. 6,463,162 (Vora), a digital watermark modulates an argument of a transform of a file. The resulting digital watermark can survive many common manipulations of audio, image, video, and multimedia data.

By including at least part of a decryption key in the digital watermark as illustrated in FIGS. 1B and 1C, additional protection is provided, such that if the digital watermark is removed or destroyed to defeat copy protection, at least part of the user data cannot be decrypted. As a result, the watermark must remain intact for copy control in compliant devices.

As an alternative to FIG. 1C, all of KEY2 may be in the first digital watermark. As still another alternative, entire identical decryption keys may be embedded in both the overhead structure and in the digital watermark. If identical decryption keys are used, a compliant drive would be prohibited from reading or copying unless both copies of the decryption key are present and identical. As a result of any of the alternatives, destruction or removal of the digital watermark would result in a data file that cannot be decrypted if copied, or a data file that a compliant drive would refuse to read or copy.

Watermark data may also be used to enhance security in transmitted data. In a second example embodiment of using a digital watermark for data protection, a compliant sink device detects whether there is a digital watermark in the user data. If a digital watermark is present, the compliant player continues to request user data. If the digital watermark is not present, the compliant player stops requesting user data. For example, in a computer system, an optical disk drive may send encrypted data to a video card or to a display. Compliant video cards or display devices would be required to detect a watermark in the decrypted data.

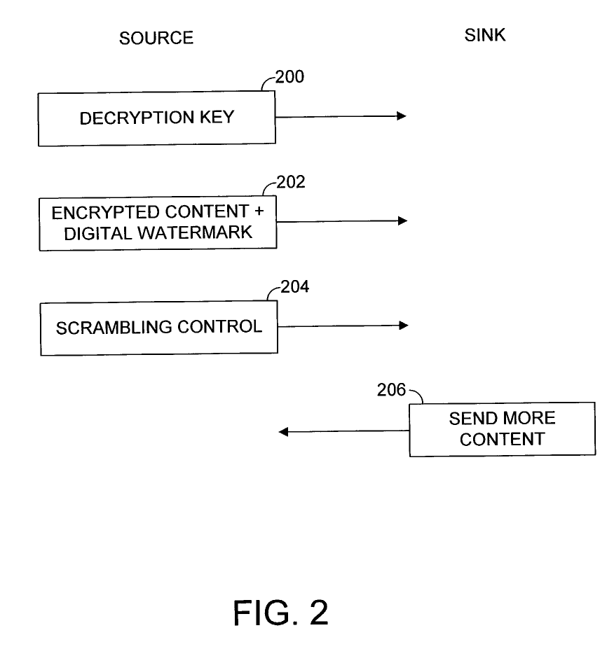

In FIG. 2, a source device sends a decryption key 200, and encrypted content including a digital watermark 202, to a sink device. The encrypted content may be sent in segments (packets, blocks, or other units of data), with the sink device providing feedback 206 indicating that the sink device is ready to receive more data. The sink device expects to see specific digital watermark data in each segment, and if the expected digital watermark data is not present, then the sink device will not request the next segment. The expected digital watermark data may be predetermined, for example, by the source device, or by both the source and the sink device. For example, the expected digital watermark data may be predetermined by the source device, and the source device may send the expected watermark data to the sink device along with the decryption key. Alternatively, the expected digital watermark data may be different for each medium, or may be different for each segment. For example, each segment may include the expected watermark data for the next segment.

In a third example embodiment of using a digital watermark for data protection, a compliant sink device unscrambles user content based on watermark data. Decrypted data may be scrambled and may include a digital watermark in the scrambled data. The digital watermark may provide instructions to the sink device on how to unscramble the data. For purposes of making data unusable, scrambling can be relatively simple, for example, exchanging a few rows or columns, or reversing order of the entire segment or part of the segment. For example, for digital video, MPEG compression typically starts groups of frames with an intracoded frame (called an I-frame) which does not depend on information from previous frames. Successive frames after the I-frame are encoded as differences from other frames, using motion vectors. An I-frame and its following difference frames is typically called a group of pictures (GOP). Video may be scrambled before compression by manipulating video data on the same GOP basis that the MPEG compression uses. One simple strategy is to randomly invert, horizontally or vertically, an I-frame image and all other images in the same GOP. Inversion of an entire GOP does not interfere with compression, but can render the video unwatchable. Watermark data may include instructions to the sink device's controller for how to undo the random inversions. Watermark data for each segment may include new instructions, or may simply include a number that indicates which one of several possible inversions was implemented for the present (or next) segment. If the digital watermark is removed, the video data would not be properly unscrambled by a sink device.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A data medium, comprising:
first data, the first data being encrypted;
a first decryption key suitable for decrypting the first data;
digital watermark data, embedded in the first data;
second data, the second data being encrypted;
a second decryption key, at least partially included in the digital watermark data, the first and second decryption keys, when combined, suitable for decrypting the second data.

2. A data medium, comprising:
first data;
digital watermark data, embedded in the first data;
second data, the second data being encrypted; and
a decryption key, at least partially included in the digital watermark data, suitable for decrypting the second data.

3. The data medium of claim 2, where the decryption key is entirely included in the digital watermark data.

4. A method comprising:
reading first data;
using a first decryption key to decrypt the first data;
extracting watermark data from the decrypted first data;
extracting a second decryption key from the watermark data;
reading second data;
using the first and second decryption keys combined to decrypt the second data.

5. A method, comprising:
reading first data;
extracting digital watermark data from the first data;
extracting at least part of a decryption key from the digital watermark data;
reading second data; and
decrypting the second data using the decryption key that was at least partially extracted from the digital watermark data.

6. A method comprising:
reading first data;
using a first decryption key to decrypt the first data;
extracting digital watermark data from the decrypted first data;
extracting a second decryption key from the digital watermark data;
reading second data; and
decrypting the second data only if the first and second decryption keys are identical.

7. A method, comprising:
transmitting first data from a source device to a sink device;
determining, by the sink device, whether digital watermark data is present in the first data; and
requesting, by the sink device, additional data from the source device only if the digital watermark data is present in the first data.

8. The method of claim 7, where the digital watermark data is predefined for the source device and the sink device.

9. The method of claim 7, further comprising:
transmitting the digital watermark data, from the source device to the sink device, separately from the first data.

10. The method of claim 7, further comprising:
reading, by the source device, the digital watermark data from a data medium; and
transmitting the digital watermark data, from the source device to the sink device, separately from the first data.

11. A method, comprising:
transmitting first data from a source device to a sink device;
extracting, by the sink device, digital watermark data from the first data;
transmitting second data from the source device to the sink device; and
requesting, by the sink device, additional data from the source device only if the digital watermark data is present in the second data.

12. A method, comprising:
scrambling data;
embedding instructions for unscrambling the data in a digital watermark; and
embedding the digital watermark in the data.

13. A method, comprising:
transmitting first data from a source device to a sink device, the data being scrambled;
extracting, by the sink device, digital watermark data from the first data;
unscrambling, by the sink device, the first data, based on information contained in the digital watermark data.

14. A system, comprising:
means for requesting first data from a source device;
means for receiving first data from a source device;
means for determining whether a digital watermark exists in the first data; and
means for requesting additional data from the source device only if the digital watermark exists in the first data.

15. A system, comprising:
means for receiving data from a source device;
means for extracting a digital watermark from the data; and
means for unscrambling the data using information from the digital watermark.

16. A system comprising:
means for embedding a digital watermark in data; and
means for embedding instructions for unscrambling the data in the digital watermark.
